(19) United States
(12) Patent Application Publication
(10) Pub. No.: US 2024/0418230 A1
(43) Pub. Date: Dec. 19, 2024

(54) BOVID HORNCORE BONE MORPHOLOGY BASED ENERGY ABSORBING STRUCTURES AND METHOD OF MAKING THEREOF

(71) Applicant: University of Massachusetts, Boston, MA (US)

(72) Inventors: Seth W. Donahue, Hadley, MA (US); Aniket Ingrole, Hadley, MA (US); Molly Costa, Hadley, MA (US)

(73) Assignee: University of Massachusetts, Boston, MA (US)

(21) Appl. No.: 18/744,761

(22) Filed: Jun. 17, 2024

Related U.S. Application Data
(60) Provisional application No. 63/508,590, filed on Jun. 16, 2023.
(60) Provisional application No. 63/631,640, filed on Apr. 9, 2024.

(51) Int. Cl. F16F 7/12; B33Y 80/00

(52) U.S. Cl. CPC F16F 7/121; B33Y 80/00; F16F 2224/0225; F16F 2224/0266; F16F 2226/00

(57) ABSTRACT

An energy absorbing structure and method of making thereof is disclosed. The energy absorbing structure comprises an energy absorbing lattice structure having an irregular, but not random, lattice pattern. The irregular lattice pattern of the energy absorbing lattice structure may be a Voronoi cell pattern, which may be derived from a bovid skull horncore morphology. Other lattice patterns may be used, such as two-dimensional tessellations forming a distribution of asymmetric polygons or three-dimensional tessellations to form a distribution of asymmetric polyhedral shapes. The energy absorbing structure may further comprise one or more substrates to one or more sides of the energy absorbing lattice structure. The energy absorbing structure may be formed through additive manufacturing and has a variety of applications including, but not limited to, helmet liners, protective gear, shoe soles, packaging material, vehicle panels, or phone cases.

### CROSS-REFERENCE TO RELATED APPLICATIONS

This patent document claims priority to earlier filed U.S. Provisional Patent Application Ser. No. 63/508,590, filed on Jun. 16, 2023, and U.S. Provisional Patent Application Ser. No. 63/631,640, filed on Apr. 9, 2024, the entire contents of which are incorporated herein by reference.

### BACKGROUND OF THE INVENTION

### 1. Field of the Invention

The present patent document is directed generally to energy absorbing structures and more particularly to improved energy absorbing structures derived from bovid horncore bone morphology and methods of making thereof.

### 2. Background of the Related Art

Energy absorbing structures are desirable in a variety of fields, including, but not limited to, helmet liners, protective gear, shoe soles, packaging material, vehicle panels, or phone cases, and the like. These structures provide a lightweight, inexpensive alternative to other heavier prior art materials and methods.

Accordingly, there is a need in the art for improved energy absorbing structures that are inexpensive and lightweight that overcome limitations of prior art materials.

### SUMMARY OF THE INVENTION

This patent document discloses embodiments of energy absorbing structures and a method of making thereof, wherein the structure comprises an energy absorbing lattice structure having an irregular, but not random, lattice pattern. Further, the energy absorbing structure may include one or more substrates connected to one or more sides of said energy absorbing lattice structure, such as, for instance, a lower substrate connected to a first side of the energy absorbing lattice and an upper substrate connected to a second side of said energy absorbing lattice structure.

In some embodiments, the irregular lattice pattern of the energy absorbing lattice structure may comprise two-dimensional tessellations to form an irregular, but not random, distribution of asymmetric polygons. In yet other embodiments, the irregular lattice pattern of the energy absorbing lattice structure may comprise three-dimensional tessellations to form an irregular, but not random, distribution of asymmetric polyhedral shapes. In yet other embodiments, the irregular lattice pattern of the energy absorbing lattice structure may comprise a Voronoi cell pattern. In yet other embodiments, the Voronoi cell pattern may be derived from bovid skull horncore morphology.

In one embodiment, the energy absorbing structure is configured and arranged for a protective article, such as, by way of example and not limitation, helmet liners, protective gear, shoe soles, packaging material, vehicle panels, or phone cases.

The patent document also discloses, a protective article that comprises an energy absorbing lattice structure having an irregular lattice pattern, where the protective article may be a helmet liner, protective gear, shoe soles, packaging material, vehicle panels, or phone cases.

The energy absorbing lattice structure of the protective article may include one or more substrate formed on one or more sides of the energy absorbing lattice structure.

In some embodiments, the irregular lattice pattern of the energy absorbing lattice structure of the protective article may comprise a Voronoi cell pattern, which, by way of example and not limitation, may be derived from a bovid skull horncore morphology.

The patent document also discloses a method of making an energy absorbing structure, which may comprise the steps of imaging an irregular, but not random, lattice pattern; generating points from the imaged irregular lattice pattern; defining three-dimensional coordinates of said points; defining regions within said points to form Voronoi cells having endpoints and external contours; and forming a mesh from the endpoints and external contours of said Voronoi cells. In some embodiments, the method may further comprise closing any gaps in the mesh.

In yet other embodiments, the method of making an energy absorbing structure may include steps of forming a lower substrate and forming the mesh on the lower substrate. And yet other embodiments may also include a step of forming an upper substrate on the mesh.

In one embodiment, the method of making an energy absorbing structure includes a step of forming the mesh through additive manufacturing.

### BRIEF DESCRIPTION OF THE DRAWINGS

These and other features, aspects, and advantages of the present invention will become better understood with reference to the following description, appended claims, and accompanying drawings where:

FIG. 1A is a perspective view of an image of a bovid skull, showing the horn and horncore morphology;

FIG. 1B is a partial longitudinal section of a horn core showing the velar bone inside the thin cortical shell, where velar structure in the compressive region of the horn core is best seen at inset B;

FIG. 1C shows a digitized image of a bovid skull, with a velar cube cropped from the compressive region of horn core best seen at inset C;

FIG. 1D shows a repaired velar cube of the horn core shown in inset C;

FIG. 2A shows a section from a CT scan of the compressive region of a horncore (similar to FIG. 1C inset);

FIG. 2B show a processed image of FIG. 2A where the image was binarized and softened with the Threshold and Smooth ImageJ© software commands;

FIG. 2C shows a Delaunay-Voronoi command in ImageJ© software split the processed image of FIG. 2B by lines of points;

FIG. 2D shows the center points of each Voronoi cell structure of FIG. 2C, which were obtained with the Ultimate Points ImageJ© software command;

FIG. 3A shows an image of the three-dimensional location of the Voronoi cell center points imported from ImageJ© software, representing the morphology of the bovid horncore bone;

FIG. 3B shows an image of the coordinates processed to obtain the three-dimensional Voronoi cell structure of FIG. 3A;

FIG. 3C shows an image of the structure following use of the explode command in Rhinoceros3D© software to break the points, edges and faces in the three-dimensional Voronoi cells of FIG. 3B;

FIG. 3D shows an image of a mesh was created from FIG. 3C;

FIG. 3E shows an image of a Weavebird Catmull Clark command in Rhinoceros3D© software used to smoothen and soften the mesh model of FIG. 3D;

FIG. 3F shows a completed three-dimensional Voronoi model of a bovid skull horncore morphology created from FIG. 3E;

FIG. 4A shows a three-dimensional printed coupon of a Voronoi model of a bovid skull horncore morphology, with solid plates on the top and bottom creating a sandwich structure for mechanical testing;

FIG. 4B shows a three-dimensional printed lattice model sandwich structure for comparison with the model of FIG. 4A;

FIG. 5 is a perspective view of an experimental setup where a three-dimensional printed structure of FIGS. 4A and 4B are placed in a mechanical loading device;

FIG. 6A shows a graph of the normalized energy absorption for three-dimensional printed structures with 70% porosity;

FIG. 6B shows a graph of the normalized energy absorption for three-dimensional printed structures with 75% porosity;

FIG. 6C shows a graph of the normalized energy absorption for three-dimensional printed structures with 80% porosity;

FIG. 7A shows an illustration of an exemplary embodiment of a lattice structure having struts with a rectangular cross-sectional area;

FIG. 7B shows an illustration of an exemplary embodiment of a lattice structure having struts with a circular cross-sectional area;

FIG. 8A shows a perspective view of an exemplary embodiment of a lattice structure having a porosity of about 80%;

FIG. 8B shows a perspective view of an exemplary embodiment of a lattice structure having a porosity of about 70%;

FIG. 8C shows a perspective view of an exemplary embodiment of a lattice structure having a porosity of about 60%;

FIG. 9A shows a cross section view of an exemplary embodiment of a helmet having protective padding formed from an embodiment of the energy absorbing structure incorporated therein;

FIG. 9B shows a front view of an exemplary embodiment of a protective padding having impact absorbing section formed from an embodiment of the energy absorbing structure incorporated therein;

FIG. 9C shows a bottom rear perspective view of an exemplary embodiment of an athletic shoe having a midsole and sole formed from an embodiment of the energy absorbing structure incorporated therein;

FIG. 9D shows a partial cross section view of an exemplary embodiment of packaging material having an inner layer formed from an embodiment of the energy absorbing structure incorporated therein;

9E shows an exploded view of an exemplary embodiment of a vehicle body having various vehicle panels formed from an embodiment of the energy absorbing structure incorporated therein; and

FIG. 9F shows a front and side perspective view of an exemplary embodiment of a phone case having an impact absorbing edge formed from an embodiment of the energy absorbing structure incorporated therein.

### DESCRIPTION OF THE PREFERRED EMBODIMENT

The present patent document discloses energy absorbing structures and method of making thereof, wherein the energy absorbing structure comprises an energy absorbing lattice structure having an irregular lattice pattern. The irregular lattice pattern may comprise two-dimensional tessellations to form an irregular, but not random, distribution of asymmetric polygons. The irregular lattice pattern of the energy absorbing lattice structure may also comprise three-dimensional tessellations to form an irregular, but not random, distribution of asymmetric polyhedral shapes. The irregular lattice pattern of the energy absorbing lattice structure may comprise a Voronoi cell pattern, which may be derived from a bovid skull horncore morphology. The lattice structure may further comprise one or more substrates connected to one or more sides of said energy absorbing lattice structure.

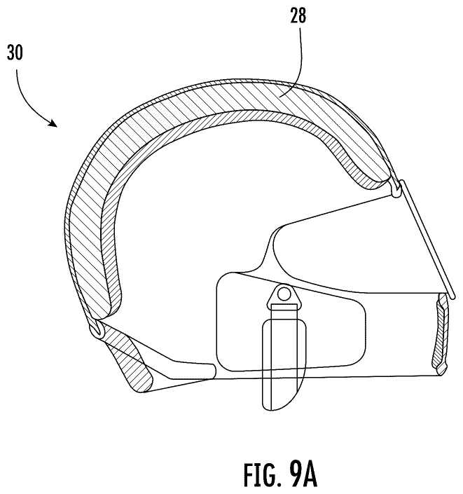

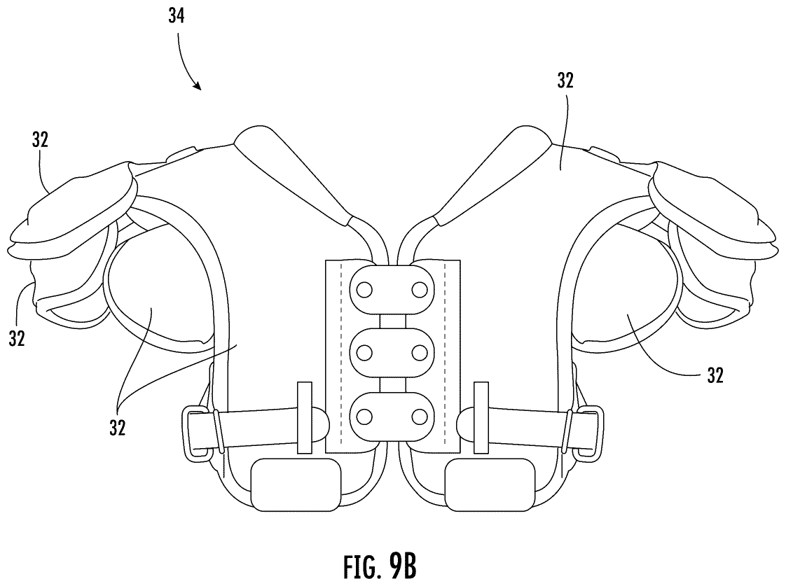

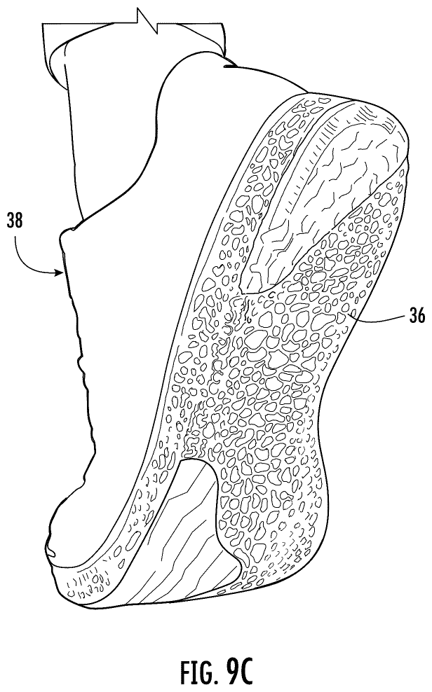

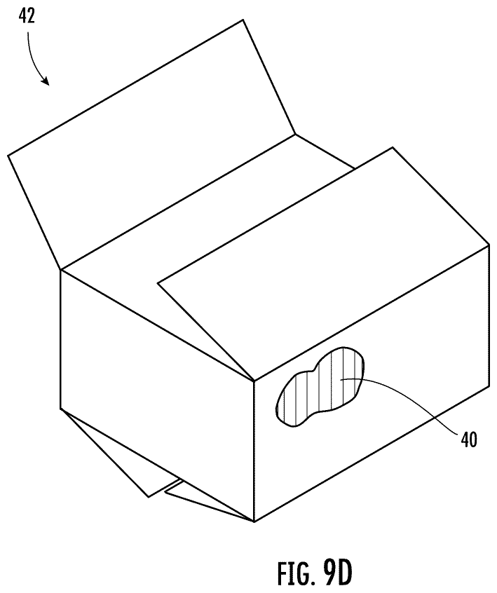

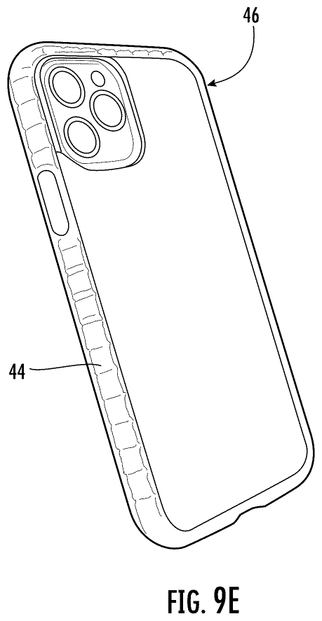

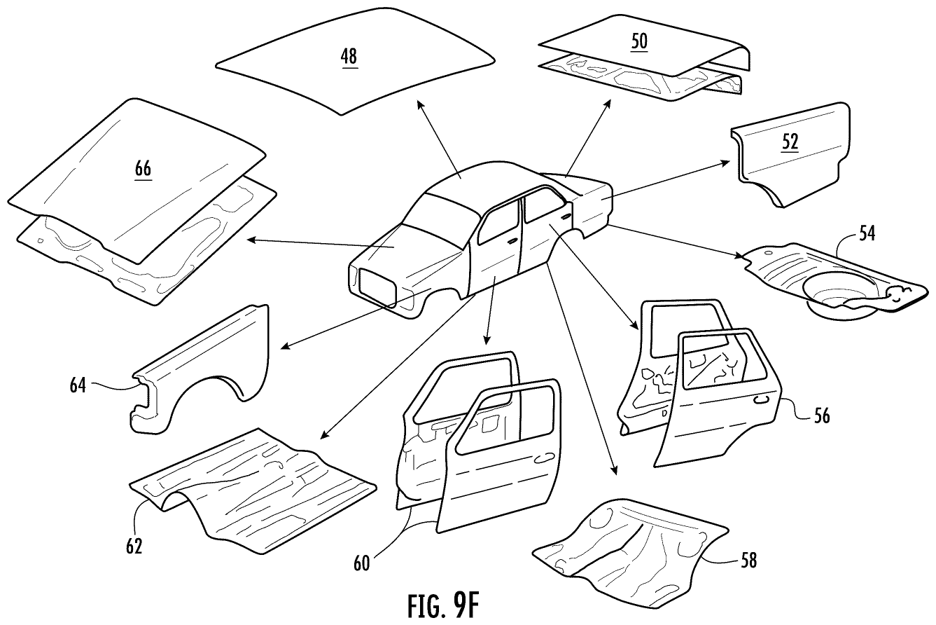

As illustrated in FIGS. 9A-9F, the energy absorbing structure may be configured and arranged for a protective articles, such as helmet liners 28 of a helmet 30 (FIG. 9A), the padding 32 of protective gear 34 (FIG. 9B), shoe soles 36 of footwear 38 (FIG. 9C), packaging material 40 of packaging 42 (FIG. 9D), the material 44 of phone cases 46 (FIG. 9F), or various vehicle panels, such as the roof panel 48, deck outer and inner panels 50, rear fender panels 52, trunk floor 54, rear outer and inner door panels 56, rear floor panel 58, front outer and inner door panels 60, front floor panel 62, front fender panels 64, and hood outer and inner panels 66 (FIG. 9E), and the like. Each article comprises one or more energy absorbing lattice structures, the energy absorbing lattice structures having an irregular lattice pattern, with optional substrates connected to one or more sides of the energy absorbing lattice structure. By way of example and not limitation, upper and lower substrates may be formed on opposites sides of the energy absorbing lattice structure.

Also disclosed, as described in greater detail below, is a method of making an energy absorbing structure, which comprises one of more of the following steps, including imaging an irregular lattice pattern, such as a bovid horncore morphology; generating points from the imaged irregular lattice pattern; defining three-dimensional coordinates of said points; defining regions within said points to form Voronoi cells having endpoints and external contours; and forming a mesh from the endpoints and external contours of said Voronoi cells. The method of making an energy absorbing structure may further comprise additional steps such as closing any gaps in the mesh.

A lower substrate may be formed, and the mesh formed on the lower substrate via an additive manufacturing method. An upper substrate may be formed on the mesh.

### Experimental Results

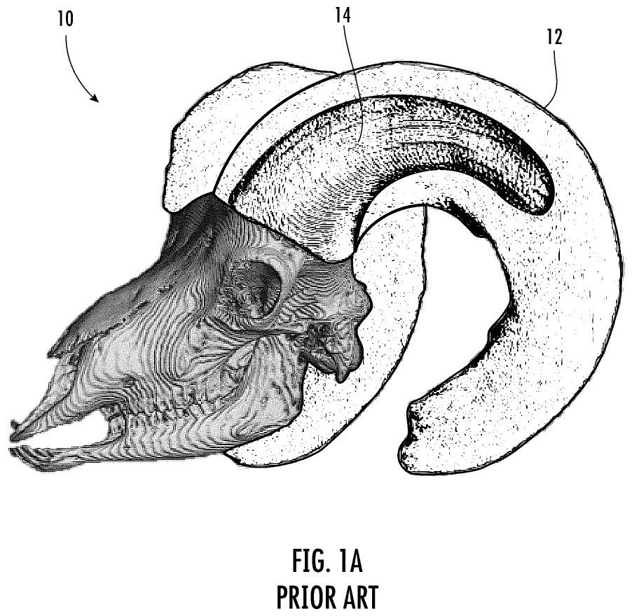

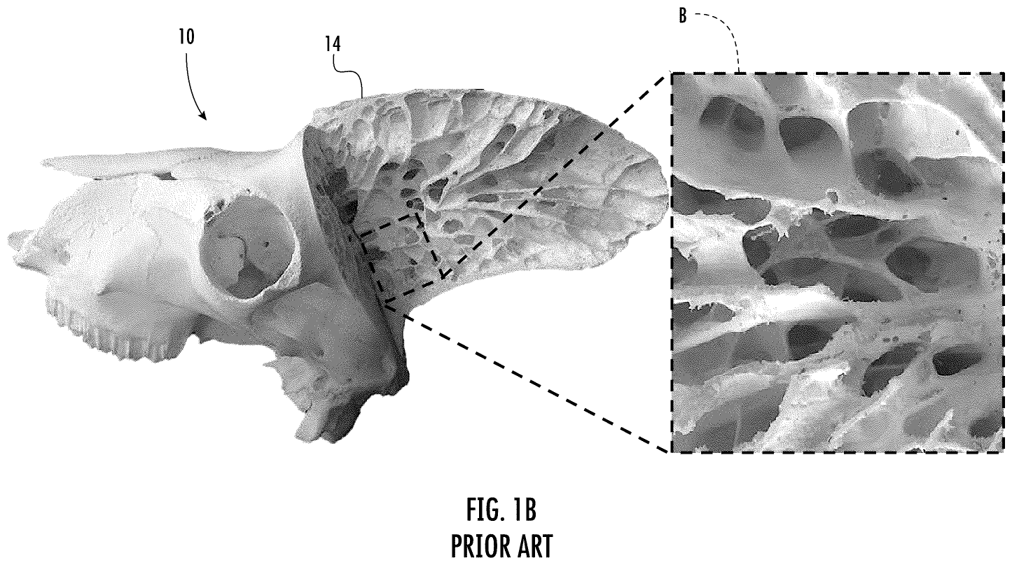

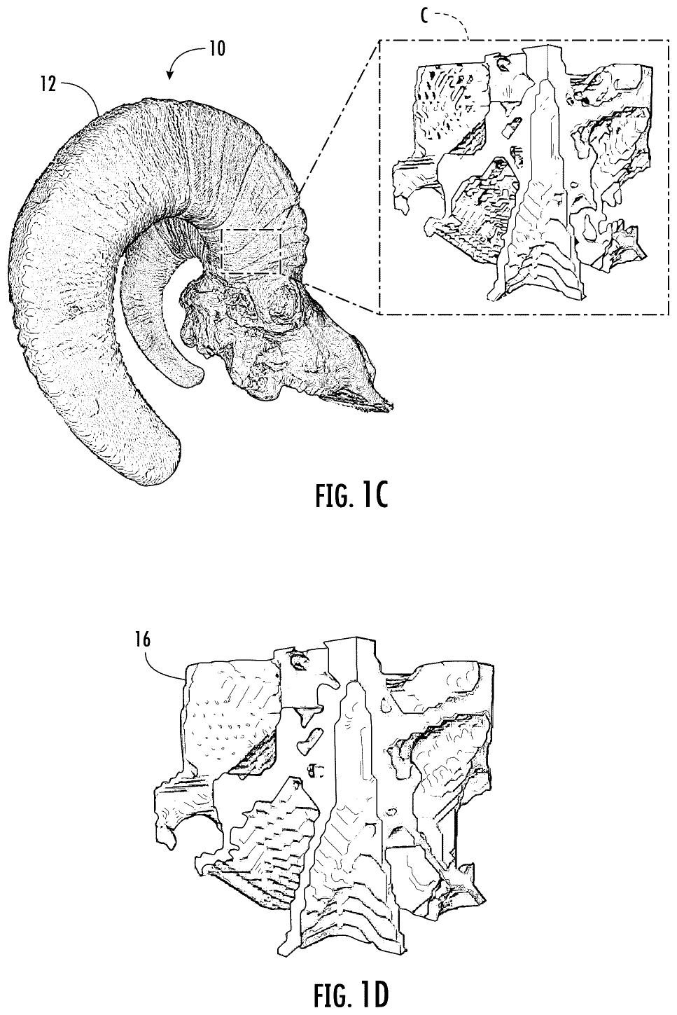

Referring now to FIGS. 1A and 1B, bighorn sheep skulls 10 were provided for research purposes by the state of Colorado Department of Natural Resources under Colorado Parks and Wildlife scientific collection license number 14SALV2052A2. Each sheep skull 10 includes a horn 12 having a horncore 14. The horncores 14 comprise a Voronoi cell structures (best seen in Inset B) that absorb impacts from ramming behavior of the bighorn sheep. As shown in FIG. 1Cs, a Gemini Time-of-Flight Big Bore PET/16 slice CT scanner (Philips Healthcare) was used to scan the skulls 10 to obtain the bone architectures from the horn's 12 horncores 14. As shown in Inset C of FIG. 1C, a specific region from the scans that experiences compressive loading during impacts was cropped to obtain a section of bone architecture. This section was determined by work done on the horn 12 and horn core 14 trabecular bone of bighorn sheep rams (Drake et al., 2016). FIG. 1D shows a repaired velar cube 16 of the horn core 14 shown in inset C.

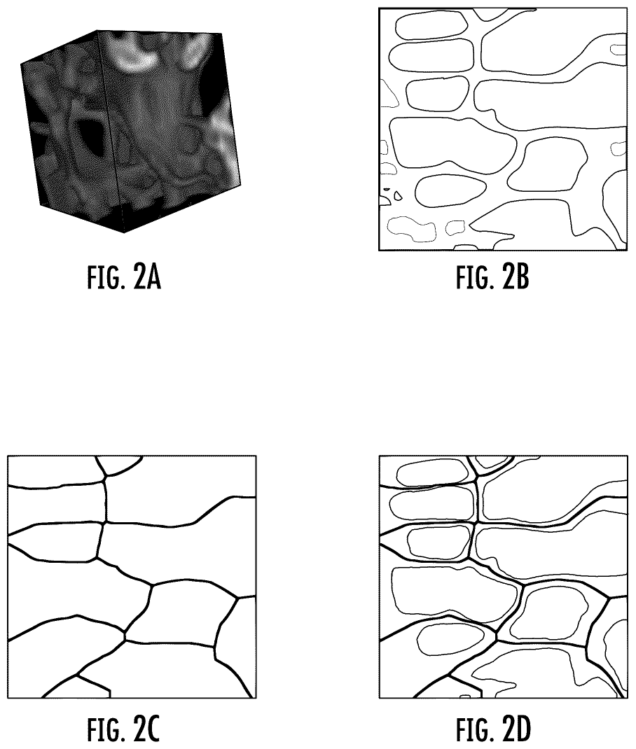

Referring now to FIGS. 2A-2D, the images from the CT scans were exported to ImageJ© software (http://imagej.nih.gov/). The images were then converted to 8-bit grey scale and Threshold and Smooth commands were used to binarize and soften to minimize the noise. The Delaunay-Voronoi command in ImageJ© was used to split the images by lines of points that have equal distance to the borders of the two nearest seed points, creating Voronoi cells. The Ultimate Points command was used to define the center point of each Voronoi cell. This process, summarized in FIGS. 2A-2D), was done to generate two-dimensional points and cells (FIGS. 2C and 2D) for each two-dimensional CT scan image (FIG. 2B) from the cropped horncore cube (FIG. 2A).

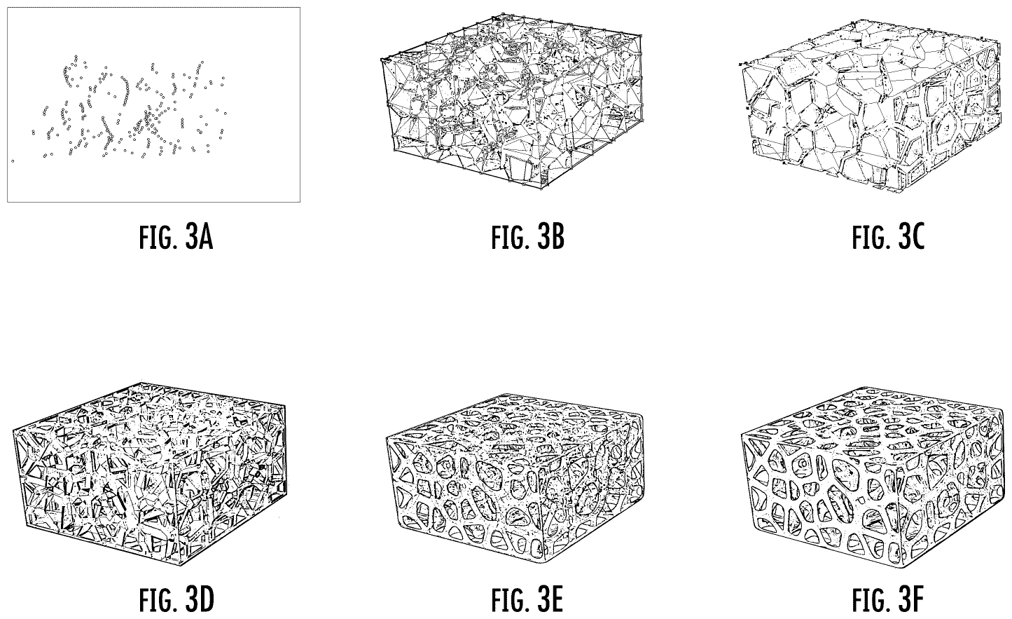

Referring now to FIGS. 3A-3F, the center points generated from ImageJ© software were then imported to Rhinoceros3D© inside a defined region of interest 40 mm×40 mm×20 mm (best seen in FIG. 3A). Once imported, the explode command was used to define three-dimensional coordinates of all the points as shown in FIG. 3B. The defined region and points were then used in Grasshopper™ plugin for Rhinoceros3D© software and were processed by the three-dimensional Voronoi command. Then the Explode command was used to break the points, edges, and faces in the three-dimensional Voronoi cells that created polyhedron cells as shown in FIG. 3C. Explode command was used again to get the endpoints and external contours of the three-dimensional Voronoi structure, as shown in FIG. 3D. Then a mesh was created, using the Mesh command, which was smoothed with Weavebird Catmull Clark command as shown in FIG. 3E. The close mesh command was then used to close any gaps present in the model, as shown in FIG. 3F. The three-dimensional bighorn sheep Voronoi modeling process using Rhinoceros3D©-Grasshopper™ is shown in FIGS. 3A-3F.

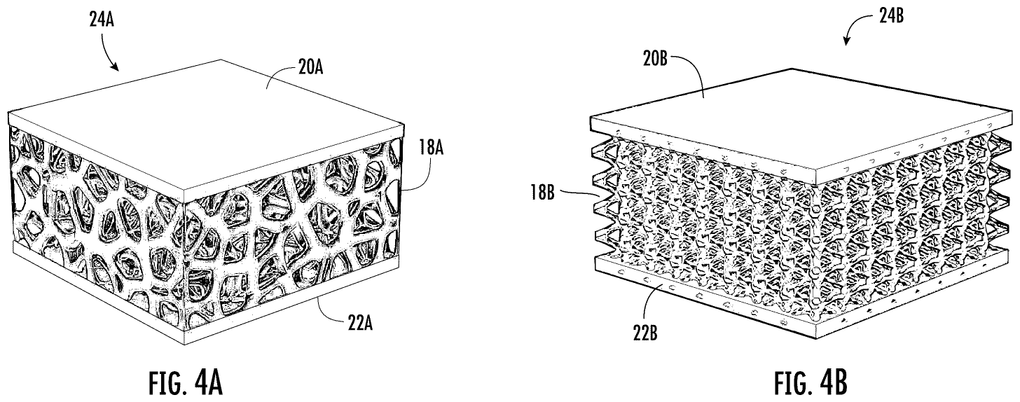

Referring now to FIGS. 4A and 4B, for comparison to the Voronoi designs, diamond lattice structures 18A, 18B similar to the Adidas running shoe midsole were also created using Rhinoceros3D©-Grasshopper™. The bighorn sheep Voronoi model and lattice model were then imported into Meshmixer software to add a 2 mm thick plate was added on top 20A, 20B and bottom 22A, 22B of the bighorn sheep Voronoi and lattice models to create a sandwich structures. These structures 24A, 24B were then exported in STL format to be used for fabricating parts using Additive manufacturing. Three different porosities (70%, 75% and 80%) were generated in Grasshopper™ to create sandwich structures. The structures were three-dimensional printed by Ramaco Carbon (Sheridan, WY) using extra tough rubber.

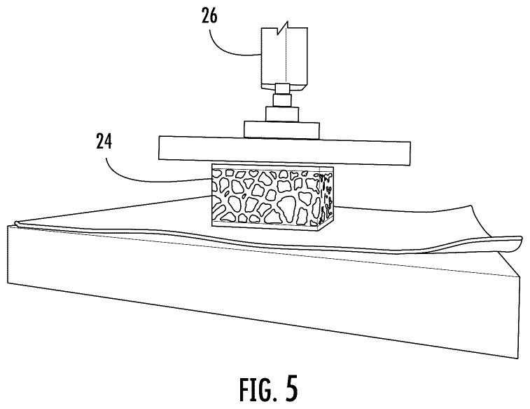

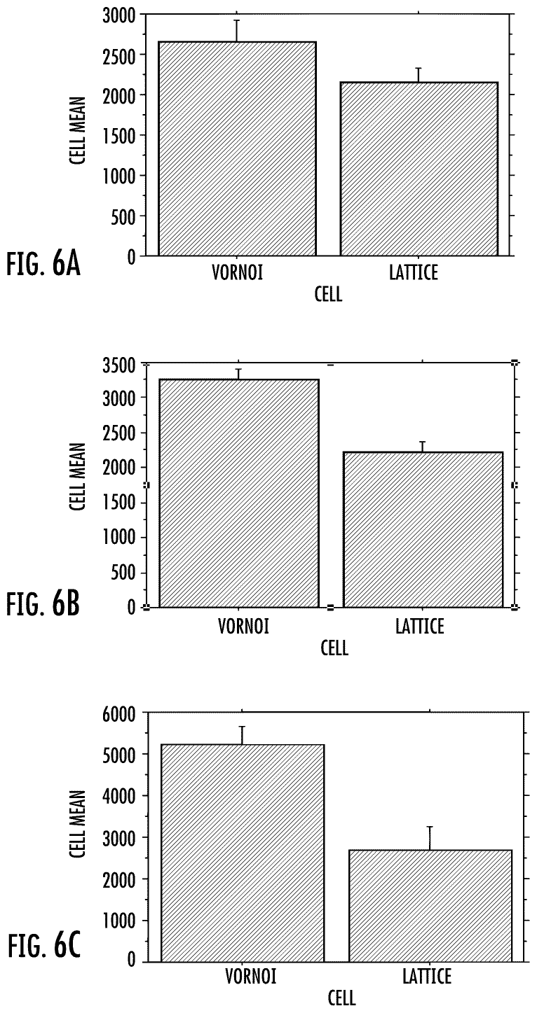

Referring to FIG. 5, three coupons 24 of each design, for each porosity, were mechanically loaded in compression for 5,005 cycles in a press 26. The maximum applied loads were approximately 800 N, 600 N, and 400 N for the 70%, 75%, and 80% porosity samples, respectively. The energy absorbed by each structure 24A, 24B was measured and plotted on the 5,005th cycle, as illustrated in FIGS. 6A-6C. To account for variability in the apparent density and applied load between samples, the absorbed energy was normalized by the apparent density and maximum applied load for each sample. When adjusting for applied load and apparent density, Voronoi structure absorbed significantly more energy than lattice structures at 75% porosity (p=0.0066) (FIG. 6B) and 80% porosity (p=0.0227) (FIG. 6C); but not at 70% porosity (p=0.2) (FIG. 6A), which may be due to the low sample size, as there was a trend for greater energy absorption in the Voronoi structures.

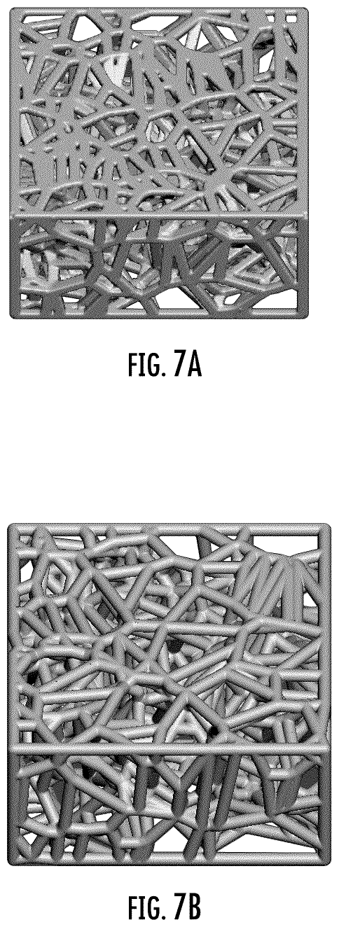

Referring to FIGS. 7A and 7B, the geometric cross-section of the struts forming the lattice structure may be selected. For instance, in FIG. 7A struts having a rectangular cross-sectional area are shown, and in FIG. 7B struts having a circular cross-sectional area are shown. The cross-sectional area of the struts may vary from strut to strut, along the length of any particular strut, or regions within the lattice structure, and may include other irregular shapes and other tailorable dimensions as desired.

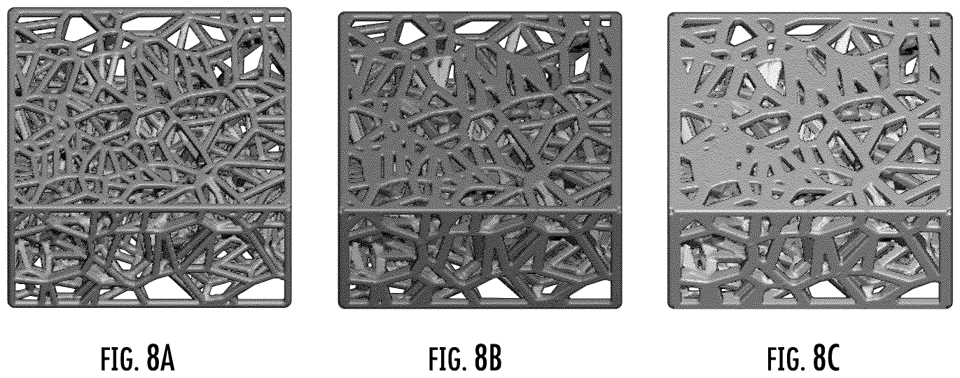

Referring to FIGS. 8A-8C, the porosity of the mesh forming the lattice structure may be selected as desired for rigidity, strength, ad elasticity. For example, in FIG. 8A the porosity is 80%, in FIG. 8B the porosity of 70%, and in FIG. 8C the porosity is 60%. Further, the porosity is tailorable and can be varied throughout different regions of the lattice structure to achieve the desired characteristics.

These findings indicate that bighorn sheep horncore inspired architectures, produced with Voronoi modeling, produce structures that have greater energy absorbing capabilities than regular diamond-shaped lattice structures.

Therefore, it can be seen that the present energy absorbing structures based on bovid horncore morphology and method of making thereof, provides an improvement over prior art energy absorbing structures, which can be implemented in a variety of applications, including, but not limited to, helmet liners, protective gear, shoe soles, packaging material, vehicle panels, or phone cases, and the like.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. An energy absorbing structure, comprising:
an energy absorbing lattice structure, the energy absorbing lattice structure having an irregular, but not random, lattice pattern.

2. The energy absorbing structure of claim 1, further comprising:
at least one substrate connected to a side of said energy absorbing lattice structure.

3. The energy absorbing structure of claim 1, wherein the lattice structure comprises struts having a variable geometric cross section.

4. The energy absorbing structure of claim 1, wherein the lattice structure comprises a variable porosity.

5. The energy absorbing structure of claim 1, wherein the irregular lattice pattern of the energy absorbing lattice structure comprises a Voronoi cell pattern.

6. The energy absorbing structure of claim 5, wherein the Voronoi cell pattern is derived from a bovid skull horncore morphology.

7. The energy absorbing structure of claim 1, wherein the energy absorbing structure is configured and arranged for a protective article.

8. The energy absorbing structure of claim 7, wherein the protective article is selected from the group consisting of: helmet liners, protective gear, shoe soles, packaging material, vehicle panels, or phone cases.

9. A protective article, comprising:
an energy absorbing lattice structure, the energy absorbing lattice structure having an irregular, but not random, lattice pattern;
wherein the protective article is selected from the group consisting of: helmet liners, protective gear, shoe soles, packaging material, vehicle panels, or phone cases.

10. The article of claim 9, further comprising:
at least one substrate formed on a side of said energy absorbing lattice structure.

11. The article of claim 9, wherein the lattice structure comprises struts having a variable geometric cross section.

12. The article of claim 11, wherein the lattice structure comprises a variable porosity.

13. The article of claim 9, wherein the irregular lattice pattern of the energy absorbing lattice structure comprises a Voronoi cell pattern.

14. The article of claim 13, wherein the Voronoi cell pattern is derived from a bovid skull horncore morphology.

15. A method of making an energy absorbing structure, comprising:
imaging an irregular, but not random, lattice pattern;
generating points from the imaged irregular lattice pattern;
defining three-dimensional coordinates of said points;
defining regions within said points to form Voronoi cells having endpoints and external contours; and
forming a mesh from the endpoints and external contours of said Voronoi cells.

16. The method of making an energy absorbing structure of claim 15, further comprising:
closing any gaps in said mesh.

17. The method of making an energy absorbing structure of claim 15, further comprising:
forming at least one substrate; and
forming the mesh on the at least one substrate.

18. The method of making an energy absorbing structure of claim 17, further comprising:
forming another substrate on the mesh.

19. The method of making an energy absorbing structure of claim 15, wherein the mesh is formed through additive manufacturing.

20. The method of claim 15, wherein the step of imaging an irregular lattice pattern comprises imaging a bovid skull horncore morphology.

21. The energy absorbing structure of claim 15, further comprising:
selecting a desired geometric cross section of a plurality of struts of the mesh.

22. The energy absorbing structure of claim 15, further comprising:
selecting a desired porosity of the mesh.
